(19) United States
(12) Patent Application Publication
(10) Pub. No.: US 2012/0191578 A1
(43) Pub. Date: Jul. 26, 2012

(54) STORAGE BATTERY MANAGING SYSTEM, AND RECYCLE EQUIPMENT AND MANAGEMENT SERVER TO BE APPLIED THEREIN

(76) Inventors: Makoto KATAGISHI, Chigasaki (JP); Tadayoshi Kosaka, Yokohama (JP)

(21) Appl. No.: 13/325,933

(22) Filed: Dec. 14, 2011

(30) Foreign Application Priority Data
Jan. 26, 2011 (JP) 2011-013573

(51) Int. Cl. G06Q 10/08

(52) U.S. Cl. 705/28

(57) ABSTRACT

In a system including a storage battery, primary use side equipment for using the battery, a management server for managing and/or reserving condition of use and histories, etc., in primary use of the storage battery, and re-use side equipment for re-using the storage battery, a condition of use when the storage battery is primarily used, and/or history thereof, etc., are recorded in the management server, and the re-use side equipment obtains the use condition and/or the histories, etc., from the management server when re-using, to notify it to a user, and thereby enabling to confirm fluctuations of performances or capacities of the storage battery, which is generated depending on the use condition when it is used primarily, when re-using the storage battery.

This application relates to and claims priority from Japanese Patent Application No. 2011-013573 filed on Jan. 26, 2011, the entire disclosure of which is incorporated herein by reference.

### BACKGROUND OF THE INVENTION

The present invention relates to a storage battery managing system for managing a storage battery.

Upon receipt of a worldwide tendency, such as, a measure against global (greenhouse) worming and/or achieving a low-carbon society, various kinds of grappling are advanced in each country. Spreading of mobile equipment and/or an automobile utilizing a storage battery therein is also advanced, wherein a method is proposed for using the storage battery exchangedly.

In this manner, accompanying with wide spreading of the storage batteries for use of the mobile equipment and for use of the automobile, generation of an enormous amount of used storage batteries can be expected in the future, and there is a necessity of taking re-processing or recycling thereof into the consideration.

On the other hand, in most families, an introduction of renewable or re-generable energy is advanced, such as, a solar power generation, etc., with aiming reduction of emissions of a greenhouse effect gas. The renewable energy can fluctuate easily, since it originates from a source of natural phenomenon, such as, the sunlight, or the wind, etc. As one of the measures for absorbing such fluctuation, it is considered to utilize the storage battery. Though developments are made on the storage batteries for exclusive use in family, however a problem to be solved lies in lowering the prices thereof. As an alternative thereof, it can be considered to re-use the above-mentioned storage batteries already used. In this instance, since the performances or capacities of the already-spent or leer storage battery differs from, depending on the condition of use in the past, there is necessity of a scheme or mechanism for enabling to confirm a background of the storage battery.

Herein, in the following Patent Document is disclosed that battery information/history of the storage battery, which is used primarily, is recorded in a management apparatus, so that the battery information/history is noticed or informed from the management apparatus.
[Patent Document 1] Japanese Patent Laying-Open No. 2007-141464 (2007).

### BRIEF SUMMARY OF THE INVENTION

However, assuming that the storage batteries are re-used, since the conditions thereof differ from, depending on, such as, a purpose when using the storage battery primarily or a kind of equipment to be connected, etc., for example, there is a high possibility that the storage batteries to be re-used generate fluctuation, individually, in the performances or capacities thereof.

Under such situation, with only the battery information/history of the storage battery or the like, which is informed from the management apparatus, for a user, it is difficult to know under which condition she/he should re-use the storage battery.

For dissolving the problem mentioned above, according to the present invention, such the structures, as will be described later, in “what is claimed”, for example, are adopted.

According to the present invention, it is possible to obtain a condition of re-use of the storage battery together with the use condition of the storage battery, which is used primarily, from a management server, when re-using or recycle equipment re-uses that storage battery, so that for the recycle equipment, upon re-using the storage battery on those information, it is possible to draw out the performances or capacities of that storage battery fitting to the characteristics thereof.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a view for explaining an example of the configuration of a storage battery managing system, according to the present invention;

FIG. 2 is an explanatory view for showing an example of a control flow of the storage battery managing system according to the present invention;

FIG. 3 is an explanatory view for showing an example of a management table of a storage battery information database in a management server according to the present invention;

FIG. 4 is an explanatory view for showing an example of the structure of a fixed control apparatus according to the present invention;

FIG. 5 is an explanatory view for showing an example of an output display of a notify means in the fixed control apparatus according to the present invention;

FIG. 6 is an explanatory view for showing an example of an output display of a notify means in the fixed control apparatus according to the present invention;

FIG. 7 is an explanatory view for showing an example of an output display of a notify means in the fixed control apparatus according to the present invention;

FIG. 8 is an explanatory view for showing an example of the structure of a mobile control apparatus according to the present invention;

FIG. 9 is an explanatory view for showing an example of the structure of a management server according to the present invention;

FIG. 10 is an explanatory view for showing an example of a management table of a storage battery information database in a management server according to the present invention;

FIG. 11 is an explanatory view for showing an example of a control flow of the storage battery managing system according to the present invention; and

FIG. 12 is an explanatory view for showing an example of a control flow of the storage battery managing system according to the present invention.

### DETAILED DESCRIPTION OF THE PREFERRED EMBODIMENTS

Hereinafter, embodiments according to the present invention will be fully explained by referring to the attached drawings. However, in the drawings, it is assumed that the same reference numeral presents the same component or the same step, etc.

### Embodiment 1

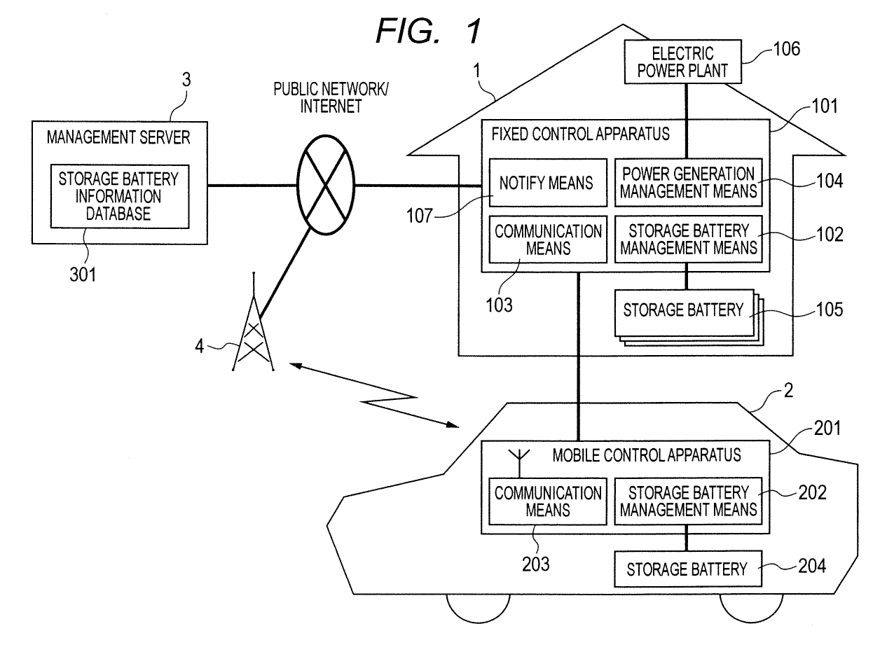

FIG. 1 shows an example of the structure or configuration of a storage battery managing system, according to a first embodiment of the present invention. In a house 1 is provided an electric power plant 106, such as, a photovoltaic (power) generation panel, etc., and a part of electric power generated with this is charged into a storage battery 105. Management of each of them is conducted by a power generation management means 104 and a storage battery management means 102. A notify means 107 has functions, such as, displaying operating conditions and giving a sound notice thereof, etc., about the electric power plant 106 and/or the storage battery 105. A communication means 103 has a function of accessing to an external management server 3.

Herein, consideration will be paid on the case where as the storage battery 105 is used a reused storage battery 205. For example, the explanation will be given on the case where the primarily use is conducted on a mobile (e.g., an automobile 2 in the figure), by referring to FIGS. 1, 2 and 3. On the automobile 2 are provided, as well as, the storage battery 204, a mobile control apparatus 201, which is equipped with a storage battery management means 202 for managing this and a communication means 203. The mobile control apparatus 201 obtains information relating to the condition of using the storage battery 204 (hereinafter, being called “storage battery information”) through the storage battery management means 202 (T101), and adds a battery ID for identifying the storage battery 204 to the storage battery information (T102). Thereafter, with using the communication means 203, the apparatus makes such a control to transmit it to the management server 3. In that instance, it may be transmitted passing through a communication base station 4. Herein, the storage battery information means, for example, a charging time, a number of times of charging, a discharging time, a number of times of discharging, a time of using, etc.

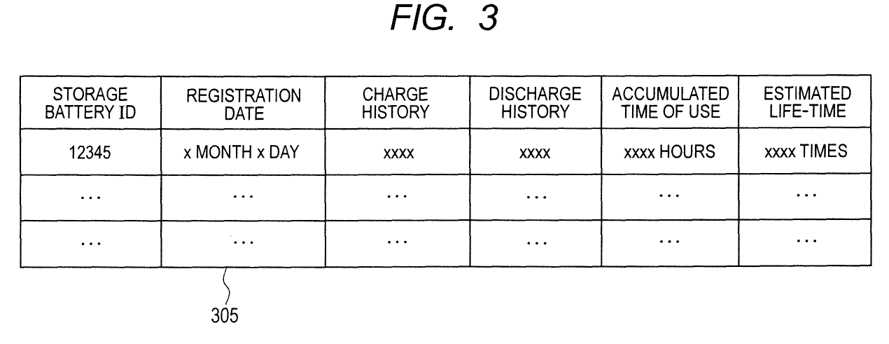

The management server 3 memorizes the battery ID and the storage battery information, which are received from the mobile control apparatus 201, within a storage battery information database 301 (T103). On a memory table managed by the storage battery information database 301 may be stored or reserved data received from the mobile control apparatus 201, directly, as it is. Or, the management server 3 may memorize the data received from the mobile control apparatus 201, into the storage battery information database 301, after processing it into a charging history, a discharging history, an accumulated time of using, a predicted lifetime, etc. In this case, as is shown in FIG. 3, the management table may record, such as, a registration date, the charging history, the discharging history, the accumulated time of using, the predicted lifetime, etc., for example. It is assumed that the processes heretofore will be called a first step.

Next, explanation will be given on a case where a user of a fixed control apparatus 101 re-uses the storage battery 204, i.e., she/he uses it as the storage battery 105 (hereinafter, the storage battery 105=the storage battery 204). The fixed control apparatus 101 detects on whether the storage battery 105 is connected with or not, with using the storage management means 102 (T104). If the storage battery 105 is connected with, the fixed control apparatus 101 detects the battery ID for identifying the storage battery 105 with using the storage management means 102 (T105), and transmits the battery ID to the server 3 with using the communication means 103. The management server 3 receiving the battery ID determines if the information corresponding to the battery ID is in the storage battery information database 301 or not (T106), and if there is no corresponding one, it makes the information to be notices to the fixed control apparatus 101, “no correspondence” (T107). If there is correspondence, apart or all of the storage battery information, which is memorized in the storage battery information database 301, is/are the information to be notice (T108 to T109). The fixed control apparatus 101 receiving the notice information notifies it to the user with using the notify means 107 (T110). It is assumed that the processes heretofore after the first step will be called a second step.

According to the present embodiment, by implementing the first and the second steps, since it is possible for the fixed control apparatus 101, being the equipment on re-using or recycling side when re-using the storage battery, to obtain the information, such as, conditions and the histories of using in the past of the storage battery, from the management server 3, so as to notify it to the user, then for the user, it is possible to confirm the background and/or the performances or capacities of the storage battery, and to use the storage battery with safety or assurance.

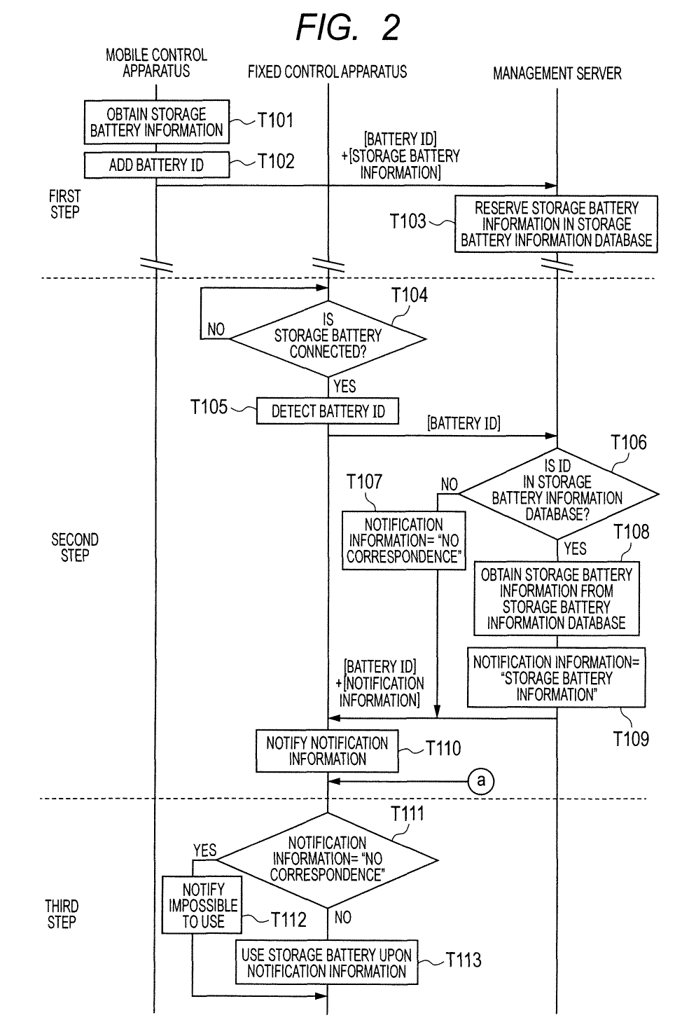

Further, the fixed control apparatus 101 receiving the information notified may set up a using condition of the storage battery 105 depending on the content of the notification. For example, as is shown in FIG. 2, in case where the notification information is “no correspondence”, the fixed control apparatus 101 notifies the user that the storage battery 105 cannot be used, with using the notify means 107 (T112). Also, in case where the information notified is the storage battery information, the fixed control apparatus 101 controls the storage battery management means 102 in such a manner that it is used upon the storage battery information received. It is assumed the processes heretofore after the second step will be called a third step.

According to the present embodiment, by implementing the third step, use of the storage battery at the equipment of the recycle side is not allowed, in case where the condition and/or the history of using, etc., during the primary use thereof are/is not recorded in the management server 3, in particular, when the fixed control apparatus 101, being the equipment on the recycle side, asks thereabout at the management server 3; therefore, it is possible to prevent a defect from being generated, beforehand, which is caused due to use of the storage battery, on which the information of the primary use thereof cannot be confirmed.

### Embodiment 2

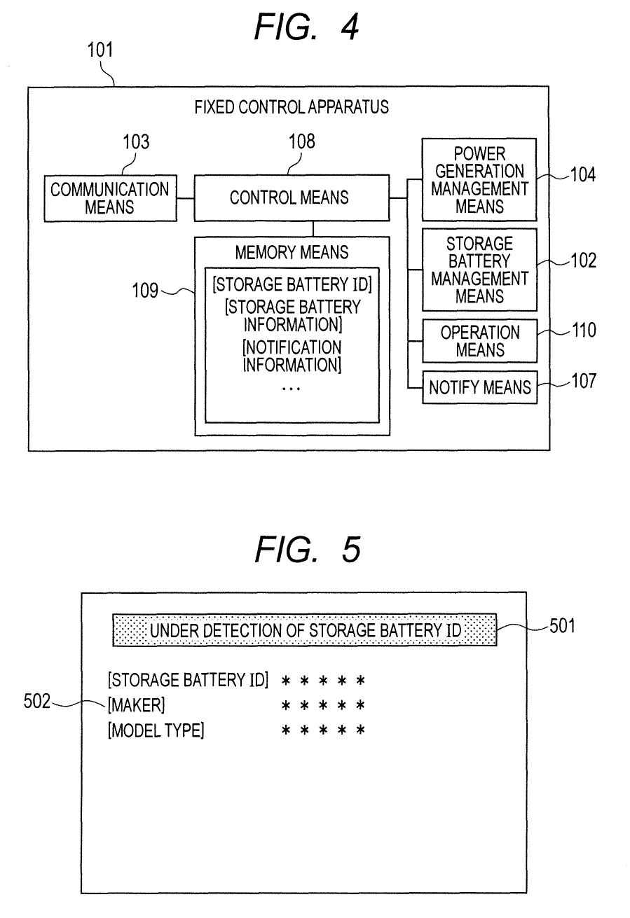

FIG. 4 shows an example of the structure of the fixed control apparatus according to a second embodiment of the present invention. A memory means 109 is for reserving the storage battery information for identifying the storage battery 105 and the notification information, which is obtained from the management server 3, etc. Also, an operation means 110 is provided for the user to input an arbitrary operation, responding to the information noticed through displaying or voices, etc., by the notify means. A control means 108 is provided for controlling the storage battery management means 102, the communication means 103, the power generation management means 104, the notify means 107 and the memory means 109.

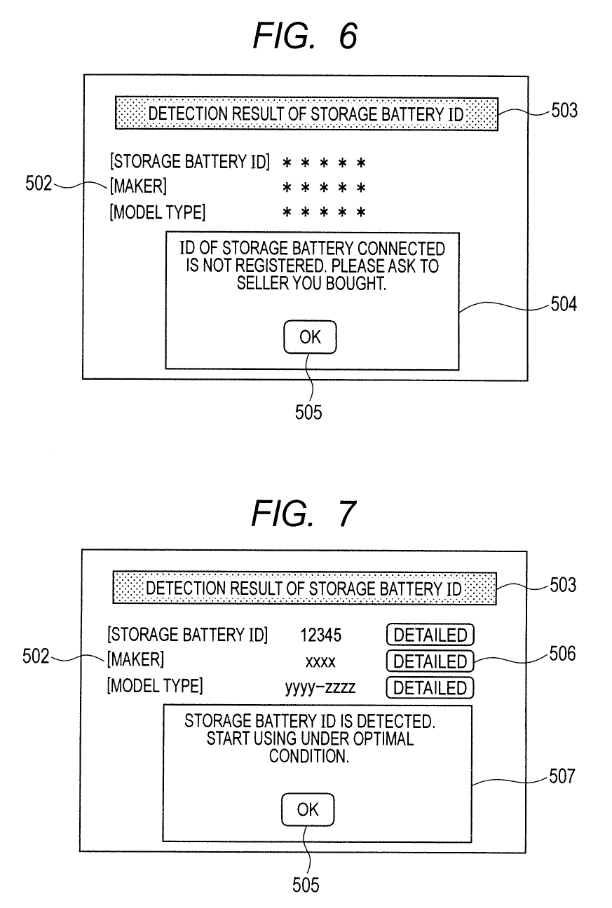

Next is shown an example of the display when the notify means 107 is a display. FIG. 5 shows an example of the display when the storage battery 105 is connected with the fixed control apparatus 101. For example, that it is under detection (501) and an item(s) to be displayed as a result of detection may be displayed, in advance (502). FIG. 6 shows an example of the display when the fixed control apparatus 101 obtains the notification information from the management server 3 and when there is no storage battery information corresponding to the battery ID even in the storage battery information database 301. As well as, displaying the fact that a detection result is obtained (503), a method for dealing with it may be presented to the user (504). Also, the fixed control apparatus 101 may control a display window of the detection result to close by means of a button (504), or may execute a contact or communication with the destination of inquiry about the dealing with, automatically. FIG. 7 shows an example of display when the fixed control apparatus 101 obtains the storage battery information corresponding to the battery ID from the management server 3. As well as, displaying the fact that the detection result is obtained (507), the content of the detection result may be displayed. Or, for the user to obtain more detailed information, a button may be displayed for presenting detailed information corresponding to a detected item (506).

According to the present embodiment, since the fixed control apparatus 101 displays the detected condition of the storage battery and/or the storage battery information with using the notify means 107, then the user can confirm the background and the performances or capacities of the storage battery, and therefore, it is possible to use the storage battery with safety. Also, when the storage battery 105, being tried to be connected with, cannot be connected, the method for dealing with is presented; therefore, the user can save time and effort of the destination, to which she/he should inquire of, i.e., the convenience can be improved. Further, with supplying the detailed information of the storage battery 105, which is connected depending on necessity thereof, it is possible to provide the fixed control apparatus 101, which can comply with various wishes of the user.

### Embodiment 3

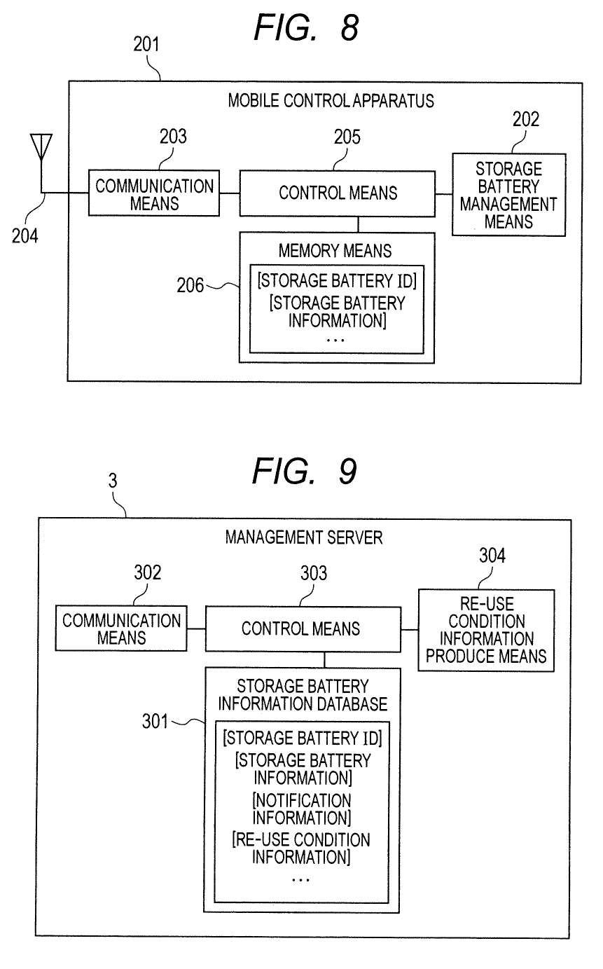

FIG. 8 shows an example of the structure of the mobile control apparatus according to a third embodiment of the present invention. A memory means 206 is for reserving therein, the battery ID for identifying the storage battery 204 and/or the storage battery information to be transmitted to the management server 3, etc. Also, a control means 205 is for controlling a storage battery management means 202, a communication means 203 and a memory means 206. Since the control means 205 can transmit the information to the management server 3 after accumulating it for a predetermined time-period, by reserving the information, such as, the condition of using the storage battery 204, etc., with using storage battery management means 202, appropriately, into the memory means 206, it is possible to reduce a number of times of communications with the mobile control apparatus 201 and the management server 3.

### Embodiment 4

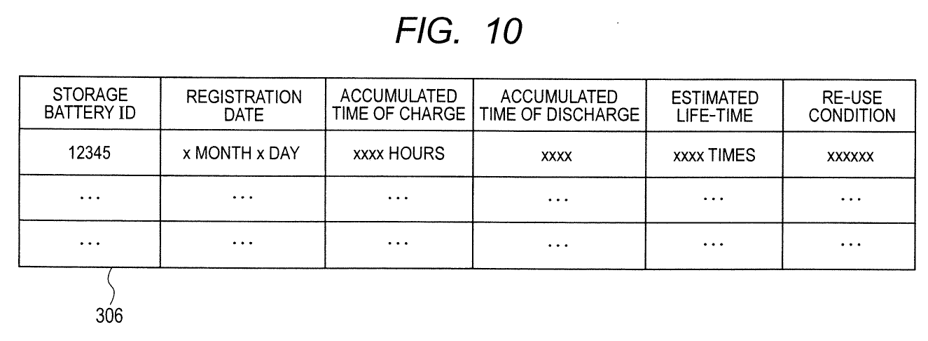

FIG. 9 shows an example of the structure of the management server according to a fourth embodiment of the present invention. A communication means 302 has a function of accessing to the fixed control apparatus 101 and the mobile control apparatus 201. Also, a re-use condition information produce means 304 is for producing a use condition (e.g., re-use condition information) when it is connected with the fixed control apparatus 101, upon basis of the data, which the management server 3 receives from the mobile control apparatus 201. The re-use condition information may be, such as, an optimal voltage to be fully charged judging from the past condition of using the storage battery, or a limit value of number of times of charging and discharging, for example. A control means 303 is provided for controlling the storage battery information database 301, the communication means 302 and the re-use condition information produce means 304, and it controls to reserve the re-use condition information, which is produced in the re-use condition information produce means 304, into the storage battery information database 301, or controls to transmit the re-use condition information to the fixed control apparatus 101, with using the communication means 302. The re-use condition information to be memorized into the storage battery information database 301 may be managed in the form of a table, as is shown in FIG. 10, for example.

According to the present embodiment, the management server produces the re-use condition upon basis of the information, such as, the condition of using and/or the histories, etc., of the storage battery when it is used primarily, thereby to transmit it to the fixed control apparatus, i.e., being the equipment of the recycle side, and therefore it is possible to pull out the performances or capacities of the storage battery fitting to the characteristics of the storage battery, with which the fixed control apparatus is connected. Also, since the re-use condition is produced on the side of the management server, it is possible to provide an optimal environment for using the storage battery, with certainty, but without compelling a burden of work, i.e., setting up a condition of use, etc., to the user of the fixed control apparatus.

### Embodiment 5

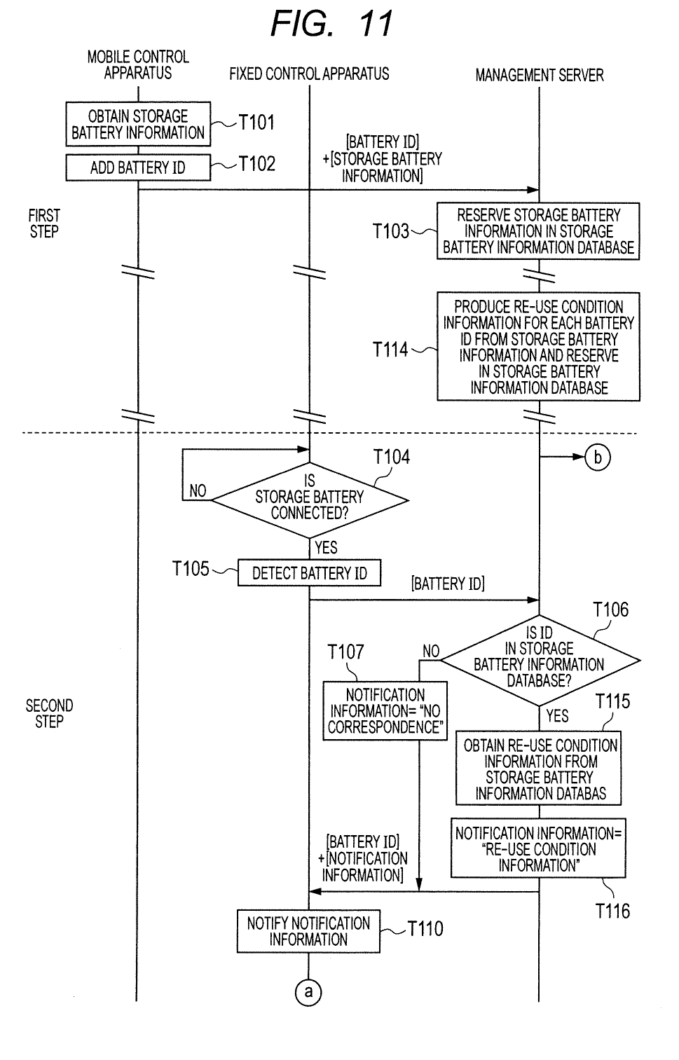

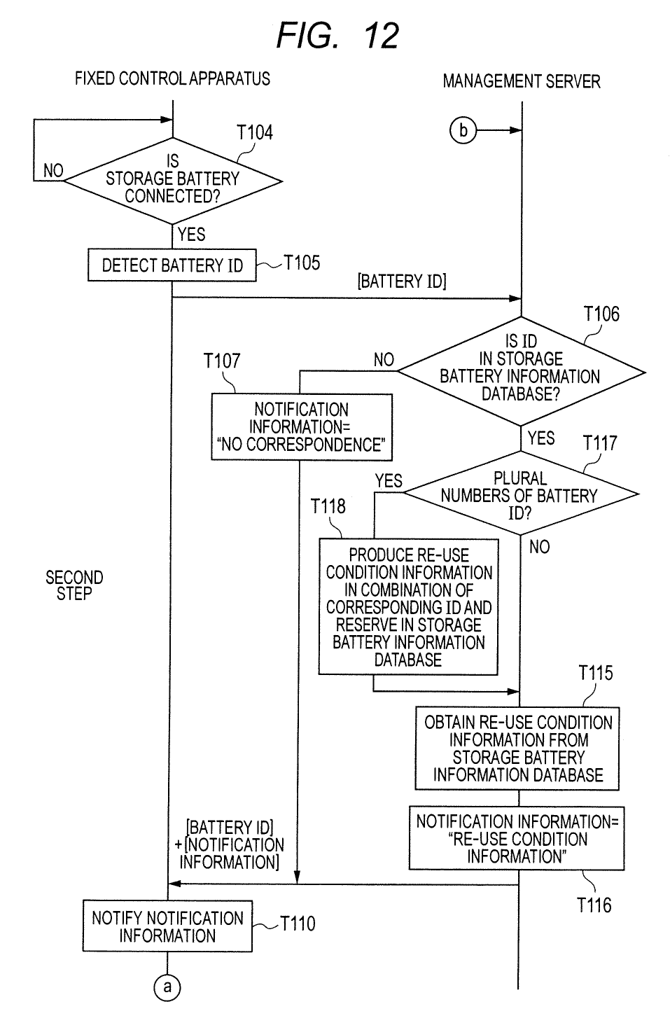

FIG. 11 shows an example of a processing flow of the storage battery managing system according to a fifth embodiment of the present invention. The present embodiment is an example of differing from the first embodiment in the processing thereof, in particular, in part of first to third steps.

Firstly in a first step, the processes up to T103 are similar to those of the first embodiment; however, the following processes are added thereafter. In more details, the management server 3 produces the re-use condition information when connecting the storage battery with the fixed control apparatus 101, upon basis of the data, which the management server 3 receives from the mobile control apparatus 201, and reserves it in the storage battery information database 301 (T114). The re-use condition information may be, such as, the optimal voltage to be fully charged judging from the past condition of using the storage battery, or the limit value of number of times of charging and discharging, for example.

Also, in a second step, the processes in T108 and T109, which are executed after the determination (T106) on whether the management server 3 receiving the battery ID has the information corresponding to the battery ID or not, within the storage battery information database 301 thereof, in the first embodiment, are changed as follows. Thus, in case where the information corresponding to the battery ID is within the storage battery information database 301, the management server 3 obtains the re-use condition information, which is memorized in the information database 301, so as to use it as the notice information (T115 through 116). Hereinafter, similar to that of the first embodiment, the fixed control apparatus 101 receiving that notice information notifies the notice information to the user with using the notify means 107 (T110).

Accompanying with the changes in the first step and the second step mentioned above, in a third step, the fixed control apparatus 101 receiving the re-use condition information controls the storage battery management means 102, in such a manner that it uses the storage battery 105 upon basis of the re-use condition information.

According to the present embodiment, since the management server produces the re-use condition upon basis of the information, such as, the conditions of use and/or the histories, etc., of the storage battery when it is used primarily, to transmit it to the fixed control apparatus, being the equipment on the recycle side, then the fixed control apparatus can pull out the performances or capacities of the storage battery fitting to the characteristics of the storage battery, with which the fixed control apparatus is connected. Also, since the re-use condition is produced on the side of the management server, it is possible to provide an optimal environment for using the storage battery, with certainty, but without compelling a burden of work, i.e., setting up a condition of use, etc., to the user of the fixed control apparatus.

### Embodiment 6

FIG. 12 shows an example of a processing flow of the storage battery managing system according to a sixth embodiment of the present invention. The present embodiment is an example of assuming plural numbers of storage batteries to be connected with the fixed control apparatus 101, wherein it differs from the fifth embodiment, in particular, in part of the second and the third steps thereof.

Firstly in a second step, the processes, which are executed after the determination (T106) on whether the management server 3 receiving the battery ID has the information corresponding to the battery ID or not, within the storage battery information database 301 thereof, in the fifth embodiment, are changed as follows. Thus, it is determined if the number of the battery ID(s), which the management server 3 receives, is plural or not (T117). In case of the plural numbers, the management server 3 produces the re-use condition information in combination with the storage battery corresponding to that battery ID, with using the re-use condition information produce means 304, and controls it to be reserved in the storage battery information database 301 (T118). Accompanying with the change in this second step, in a third step, the fixed control apparatus 101 receiving the re-use condition information in the combination of plural numbers of the storage batteries controls the storage battery management means 102 to use the storage battery 105 upon basis of the re-use condition information.

According to the present embodiment, since the management server produces the re-use condition upon basis of the information, such as, the conditions of use and/or the histories, etc., of the storage battery when it is used primarily, to transmit it to the fixed control apparatus, being the equipment on the recycle side, then the fixed control apparatus can pull out the performances or capacities of the storage battery fitting to the characteristics of the storage battery, with which the fixed control apparatus is connected. Also, since the re-use condition is produced on the side of the management server, it is possible to provide an optimal environment for using the storage battery, with certainty, but without compelling a burden of work, i.e., setting up a condition of use, etc., to the user of the fixed control apparatus. Further, with provision of a specification condition when combining the plural numbers of storage batteries to be re-used, from the management server to the fixed control apparatus, it is possible to achieve a flexible storage battery managing system irrespective of the number of pieces of the storage batteries.

However, the explanation was given on the case where the equipment, with which the storage battery is used primarily, is the automobile; however, it is apparent that the similar effect(s) can be obtained as far as it is the equipment using the storage battery therein.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A storage battery managing system, comprising:
recycle equipment, which re-uses a storage battery primarily used; and
a management server, which is connected with said equipment through a network, wherein
said management server has a storage battery information database, which is configured to manage storage battery information in relation to a condition of using the storage battery used primarily for each of plural numbers of storage batteries with using an ID thereof, a re-use condition information produce portion, which is configured to produce re-use condition information of the storage battery from said storage battery information, to be managed in said storage battery information database, a communication portion, which is configured to communicate with said recycle equipment, and a control portion, which is configured to control those,
said recycle equipment has a storage battery to be re-used, a communication portion, which is configured to communicate with said management server, and a storage battery management portion, which is configured to manage use of said storage battery, wherein
the storage battery management portion of said recycle equipment inquires of the ID of the storage battery to be re-used to the management server, through the communication portion,
the control portion of the management server extracts storage battery information including the re-use condition information, which is managed by the ID of the storage battery, from the storage battery information database, and transmits it to the recycle equipment through the communication portion, and
the storage battery management portion of the recycle equipment manages the storage battery to be used upon basis of said storage battery information, when receiving the storage battery information including the re-use condition information from the management server, through the communication portion.

2. The storage battery managing system, as described in the claim 1, wherein
in case where said recycle equipment re-uses plural numbers of storage batteries,
the storage battery management portion of said recycle equipment inquires of plural number of IDs of the storage batteries to be re-used to the management server, through the communication portion,
the re-use condition information produce portion of the management server re-produces the re-use condition information for re-using the plural numbers of storage batteries, from said storage battery information, which is managed with using the plural numbers of IDs of the storage batteries, to be managed within the storage battery information database,
the control portion of the management server extracts the storage battery information including the re-use condition information for use of re-using the plural number of storage batteries, for each plural numbers of IDs of the storage batteries, and transmits it to the recycle equipment through the communication portion, and
the storage battery management portion of the recycle equipment manages the storage batteries to be used upon basis of said storage battery information, when receiving the storage battery information including the re-use condition information for use of re-using the plural numbers of storage batteries, for each plural numbers of IDs of the storage batteries, from the management server, through the communication portion.

3. The storage battery managing system, as described in the claim 1, wherein
the control portion of the management server transmits that there is no storage battery information to the recycle equipment from the communication portion, when there is no storage battery information, which is managed by the ID of the storage battery to be re-used, and
the storage battery management portion of said recycle equipment manage the storage battery not to be re-used, when receiving a notice that there is no storage battery information, from the management server, through the communication server.

4. A management server for a storage battery managing system, having recycle equipment, which re-uses a storage battery primarily used, and a management server, which is connected with said equipment through a network, comprising:
a storage battery information database, which is configured to manage storage battery information in relation to a condition of using the storage battery used primarily for each of plural numbers of storage batteries with using an ID thereof;
a re-use condition information produce portion, which is configured to produce re-use condition information of the storage battery from said storage battery information, to be managed in said storage battery information database;
a communication portion, which is configured to communicate with said recycle equipment; and
a control portion, which is configured to control those, wherein
said control portion extracts storage battery information including the re-use condition information, which is managed by the ID of the storage battery, from the storage battery information database, and transmits it to the recycle equipment by means of the communication portion, when the inquiry of the ID of the storage battery to be re-used from said recycle equipment.

5. The management server, as described in the claim 4, wherein in case where said recycle equipment re-uses plural numbers of storage batteries,
said re-use condition information produce portion re-produces the re-use condition information for use of re-using the plural numbers of storage batteries from said storage battery information, which is managed by plural numbers of IDs of batteries, to be managed in the storage battery information database, when there is an inquiry in relation to the plural numbers of IDs of the storage batteries to be re-used from said recycle equipment, and said control portion extracts the storage battery information including the re-use condition information for re-using the plural numbers of storage batteries, for each ID of the plural numbers of storage batteries, and transmit it to the recycle equipment by means of the communication portion.

6. The management server, as described in the claim 4, wherein
said control portion transmits that there is no storage battery information to the recycle equipment from the communication portion, when there is no storage battery information, which is managed by the ID of the storage battery to be re-used.

7. Recycle equipment for a storage battery managing system, having recycle equipment, which re-uses a storage battery primarily used, and a management server, which is connected with said equipment through a network, comprising:
a storage battery to be re-used;
a communication portion, which is configured to communicate with said management server; and
a storage battery management portion, which is configured to manage use of said storage battery, wherein
said storage battery management portion inquires of an ID of the storage battery to be re-used to the management server, through the communication portion, and manages the storage battery to be used upon basis of storage battery information, when receiving said storage battery information including re-use condition information, which is managed by an ID of the storage battery, from the management server.

8. The recycle equipment, described in the claim 7, wherein
in case when re-using plural numbers of said storage batteries,
said storage battery management portion manages the storage batteries to be used upon basis of storage battery information, when receiving said storage battery information including re-use condition information for re-using the plural numbers of storage batteries, for each ID of plural numbers of storage batteries, from the management server, through the communication portion.

9. The recycle equipment, described in the claim 7, wherein said storage battery management portion manages the storage battery not to be re-used, when receiving a notice that there is no storage battery information, which is managed by the ID of the storage battery to be re-used, from the management server, through the communication portion.
